(19) United States
(12) Patent Application Publication
(10) Pub. No.: US 2018/0221794 A1
(43) Pub. Date: Aug. 9, 2018

(54) FILTER SYSTEM

(71) Applicant: QINGDAO ECOPURE FILTER CO., LTD., QINGDAO (CN)

(72) Inventor: Zou Zhibin, Qingdao (CN)

(73) Assignee: QINGDAO ECOPURE FILTER CO., LTD., QINGDAO (CN)

(21) Appl. No.: 15/945,234

(22) Filed: Apr. 4, 2018

Related U.S. Application Data
(63) Continuation-in-part of application No. 15/166,231, filed on May 26, 2016.
Application No. 15/166,231 is a continuation-in-part of application No. 29/564,197, filed on May 11, 2016, now abandoned.
Application No. 29/564,197 is a continuation-in-part of application No. 29/564,270, filed on May 11, 2016, now abandoned.
Application No. 29/564,270 is a continuation-in-part of application No. 29/564,262, filed on May 11, 2016, now abandoned.
Application No. 29/564,262 is a continuation-in-part of application No. 29/564,255, filed on May 11, 2016, now abandoned.
Application No. 29/564,255 is a continuation-in-part of application No. 15/194,441, filed on Jun. 27, 2016, now abandoned.
Application No. 15/194,441 is a continuation-in-part of application No. 15/166,231, filed on May 26, 2016.
Application No. 15/166,231 is a continuation-in-part of application No. 15/200,697, filed on Jul. 1, 2016.

(51) Int. Cl. B01D 29/96; B01D 29/11

(52) U.S. Cl. CPC B01D 29/96; B01D 29/114; B01D 2201/303; B01D 2201/304; B01D 2201/4092; B01D 2201/306

(57) ABSTRACT

A system is disclosed that may include a first filter that is effective in removing heavy metals and a filter cartridge that is installed in an appliance for a second filter within the appliance. The second filter may not be effective for removing heavy metal from the fluid. The filter cartridge that is installed within the appliance does not need to include a filter.

### CROSS-REFERENCE TO RELATED APPLICATIONS

This Application is a continuation-in-part of U.S. patent application Ser. No. 15/166,231 (Docket NO. CO-1), entitled “Reusable Filter System,” by Zhibin Zou, filed May 26, 2016, which is incorporated herein by reference, which in turn is a continuation-in-part of

U.S. patent application Ser. No. 29/564,197 (Docket No. CO-2), entitled “Filter Unit,” by Zhibin Zou, filed May 11, 2016,

U.S. patent application Ser. No. 29/564,255 (Docket No. CO-3), entitled “Filter Unit,” by Zhibin Zou, filed May 11, 2016,

U.S. patent application Ser. No. 29/564,262 (Docket No. CO-4), entitled “Filter Unit,” by Zhibin Zou, filed May 11, 2016, and

U.S. patent application Ser. No. 29/564,270 (Docket No. CO-5), entitled “Filter Unit,” by Zhibin Zou, filed May 11, 2016;

this application is a continuation-in-part of U.S. patent application Ser. No. 15/194,441 (Docket No. CO-6), entitled “Reusable Filter System,” by Zhibin Zou, filed Jun. 27, 2016; which in turn is a continuation-in-part of U.S. patent application Ser. No. 15/166,231 (Docket No. CO-1), entitled “Reusable Filter System,” by Zhibin Zou, filed May 26, 2016;

this application is a continuation-in-part of U.S. patent application Ser. No. 15/200,697 (Docket No. CO-10), entitled “Water Filter,” by Zhibin Zou, filed Jul. 1, 2016.

All of the above Applications are incorporated herein by reference.

### FIELD

This specification relates generally to the purification of fluids.

### BACKGROUND

The subject matter discussed in the background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represent different approaches, which in and of themselves may also be inventions.

Fluid filter systems remove impurities from fluid, such as water, so as to fulfill various requirements (e.g., for drinking purpose, medical use, industrial use, etc.). This specification recognizes the need for operating various filter systems without the filter present.

The size of a filter cartridge, and the lifetime of filter cartridge may be limited by the environment in which the filter cartridge is intended to operate. For a filter cartridge that is of an appropriate size for installation within a refrigerator, the life time for which the filter cartridge remains effective in reducing heavy metal, may only be 200 or 300 gallons, which may mean that the filter will need to be changed in a very short time.

### BRIEF DESCRIPTION OF THE FIGURES

In the following drawings, like reference numbers are used to refer to like elements. Although the following figures depict various examples of the invention, the invention is not limited to the examples depicted in the figures.

FIG. 1 shows a diagram of an embodiment of a fluid filter system.

FIG. 2 shows an exploded view of an embodiment of a filter system that may be used for the filter system of FIG. 1.

FIG. 3 shows a top perspective view of an embodiment of the top of a manifold that may be used in the embodiment of FIG. 1.

FIG. 4 shows a top view of an embodiment of a manifold that may be used in the embodiment of FIG. 1.

FIG. 5 shows a bottom perspective view of a manifold that may be used in the embodiment of FIG. 1.

FIG. 6 shows the bottom view of a manifold that may be used in the embodiment of FIG. 1.

FIG. 7 shows an exploded view of a manifold and manifold cover that may be used in the embodiment of FIG. 1.

FIG. 8 shows a cross section of an embodiment of a filter head that may be used in the embodiment of FIG. 1.

FIG. 9 shows a top view of an embodiment of a manifold cover that may be used in the embodiment of FIG. 1.

FIG. 10 shows a bottom view of an embodiment of a manifold cover that may be used in the embodiment of FIG. 1.

FIG. 11 shows a perspective view of the top side of an embodiment of a manifold cover that may be used in the embodiment of FIG. 1.

FIG. 12 shows a perspective view of an o-ring, which may be an embodiment of any of the o-rings used in this specification.

FIG. 13 shows a side view of an embodiment of a cartridge cover that may be used with the cartridge used in the embodiment of FIG. 1.

FIG. 14 shows a bottom view of an embodiment of a cartridge cover that may be used with the cartridge used in the embodiment of FIG. 1.

FIG. 15 shows a top view of an embodiment of a cartridge cover that may be used with the cartridge used in the embodiment of FIG. 1.

FIG. 16 shows a top perspective view of an embodiment of a cartridge cover that may be used with the cartridge used in the embodiment of FIG. 1.

FIG. 17 shows a bottom view of an embodiment of a fluid distributor that may be used with the cartridge used in the embodiment of FIG. 1.

FIG. 18 shows a top perspective view of an embodiment of a fluid distributor that may be used with the cartridge used in the embodiment of FIG. 1.

FIG. 19 shows a bottom perspective view of an embodiment of a fluid distributor that may be used with the cartridge used in the embodiment of FIG. 1.

FIG. 20 shows a perspective view of an embodiment of a filter cover that may be used with the cartridge used in the embodiment of FIG. 1.

FIG. 21 shows a perspective view of an embodiment of a filter element that may be used with the cartridge used in the embodiment of FIG. 1.

FIG. 22 shows a bottom view of an embodiment of a canister that may be used with the cartridge used in the embodiment of FIG. 1.

FIG. 23 shows a perspective view of an embodiment of a canister that may be used with the cartridge used in the embodiment of FIG. 1.

FIG. 24 shows a top view of an embodiment of a canister that may be used with the cartridge used in the embodiment of FIG. 1.

FIG. 25 shows a cross sectional view of the filter system that may be used in the embodiment of FIG. 1 with an empty filter cartridge attached to the connector.

FIG. 26 shows a front view of an embodiment of the filter cartridge, which shows the shape of one embodiment of the opening in the neck that may be with the cartridge, used in the embodiment of FIG. 1.

FIG. 27 shows an embodiment of a refrigerator and filter system within which an embodiment of the filter system of FIG. 1 may be used (with the refrigerator doors open).

FIG. 28 shows an embodiment of another view of the refrigerator and filter system within which an embodiment of the filter system of FIG. 1 may be used (with the refrigerator doors open).

FIG. 29 is a flowchart of an embodiment of a method of using an embodiment of the fluid filter system of FIGS. 1-28.

FIG. 30 is a flowchart of an embodiment of a method of making an embodiment of the filter cartridge of FIGS. 1-28.

FIG. 31 is a flowchart of an embodiment of a method of making an embodiment of the filter head of the filter system of FIGS. 1-28.

FIG. 32 shows the cross sectional view of the outside filter of FIG. 27.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

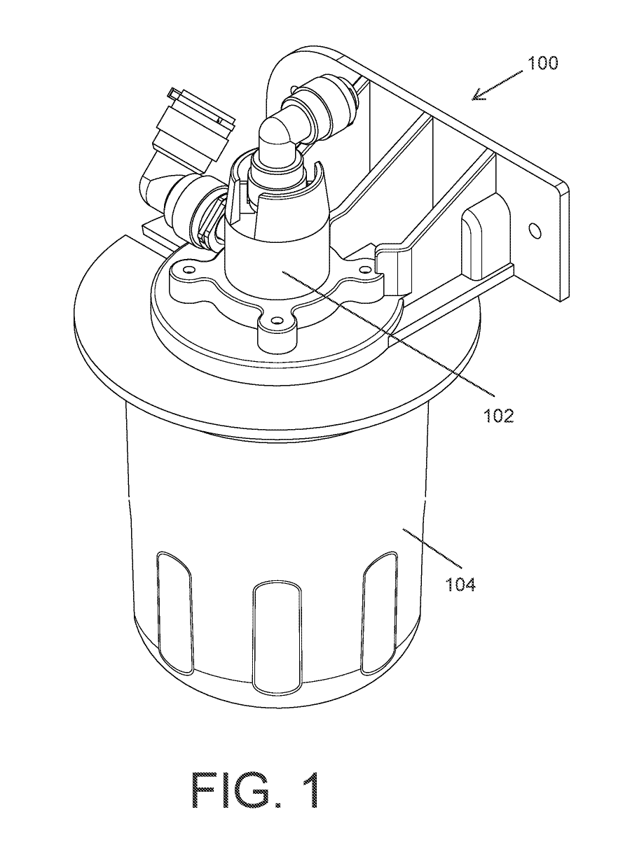

In general, at the beginning of the discussion of each of FIGS. 1-28 is a brief description of each element. After the brief description of each element, each element is further discussed, usually in numerical order. Additionally, in various locations, headings are used to improve the readability of the application. However, despite the organizational features of the application, such as the headings and the discussion of each element in numerical order, there is no one location where all of the information of any element of FIGS. 1-28 is necessarily located. Unique information about any particular element or any other aspect of any of FIGS. 1-28 may be found in, or implied by, any part of the specification.

FIG. 1 shows a diagram of an embodiment of a fluid filter system 100. The fluid filter system 100 includes at least filter head 102 and cartridge 104. In other embodiments, the fluid filter system 100 may not include all of the components listed and/or may include other components in addition to or instead of those listed above.

In at least one embodiment, the fluid filter system 100 (which may be referred to as a water filter assembly) includes an optional filter element, and may be operated without the filter element. In at least one embodiment, a cartridge filter that does not have a heavy metal reduction filter media inside is installed. In an embodiment, a toxic heavy metal may be any relatively dense metal or metalloid that is noted as potentially being toxic Some examples of heavy metals are cadmium, mercury, lead, and arsenic. Other examples of heavy metals are beryllium, aluminum, chromium, manganese, iron, cobalt, nickel, copper, zinc, arsenic, selenium, molybdenum, silver, cadmium, tin, antimony, barium, mercury, thallium, and lead.

The function of the cartridge may only be to open the shut off valve of the filter head or stop fluids from leaking to the refrigerator if there is no valve to prevent leaks. In an embodiment, there is a fluid filter system outside the refrigerator and connected to the fluid source at the inlet end of the filter outside of the refrigerator and is connected to the fluid inlet of the refrigerator at the outlet end of the filter outside of the refrigerator. In this specification, the words refrigerator and fridge are used interchangeably. Either word may be substituted for the other in any location of the specification to get a different embodiment. The filter outside of the refrigerator has a longer lifetime during which the filter is effective in reducing heavy metals (and/or other substances) in the water (and/or other fluids). The filter outside of the refrigerator is more effective in removing heavy metals (and/or other substances) than the filter in the refrigerator. In other words, a manner of improving a refrigerator water filter system, may include installing a filter cartridge or water filter element in a filter cartridge (e.g., where the water filter element does not reduce heavy metals) in the filter head of refrigerator, then a second water filter system that is effective in filtering heavy metals is connected between the water source (e.g., the water source for the home or from the refrigerator) and water inlet of the refrigerator. The water cartridge installed in the refrigerator (and/or outside of the refrigerator) may have a filter material that improves the function of the water filter system.

For example, the user may own a refrigerator (or other appliance) that includes a water filter. However, the filter system that comes with the refrigerator may have a small filter element that needs to be replaced frequently or may not purify water as well as the user may desire. Accordingly, the user installs a separate filter that is larger and/or a higher quality filter between a water source and the refrigerator at the water inlet to the refrigerator (the “water inlet” being end of the pipe, tube, or other conduit where water enters the appliance) and/or for the entire household. It may be desirable for a filter head to have a shutoff valve, so that if the user does not shutoff the water to the refrigerator when changing the filter cartridge, the water does not pour all over the floor. Additionally, the filter head may be designed so that the user can change the filter cartridge without shutting off the water to the water dispenser. However, if the filter head has a shutoff valve, the refrigerator's water dispenser may not function without a filter cartridge present. Accordingly, a filter cartridge without the heavy reduction filter element is installed to keep the filter head open, while the filter outside of the refrigerator filters the water.

The filter head 102 is the top portion of filter system 100 installed within the refrigerator. The filter head 102 is attached to the inlet conduits and outlet conduits of the refrigerator and is mounted on the refrigerator. Fluid, from which heavy metals (or other substances) have been removed by the external filter, enters filter system 100, via an inlet of the filter head 102, into filter system 100 for optional further purification, and the further purified fluid from within the filter system 100 exits filter system 100 into the outlet conduit of the refrigerator (e.g., a water dispenser). Unless stated otherwise, when discussing filter system 100, the unpurified fluid, refers to fluid from which heavy metals (or other substances intended be removed by that the outer filter) has been removed by the external filter, but the fluid has not been further purified by filter system 100.

Cartridge 104 is connected to the filter head 102 and holds the filter element. Cartridge 104 is held in the refrigerator by filter head 102. Cartridge 104 may be removably attached to filter head 102. In this specification, the terms “removable,” “removably,” and “detachable” refer to being easily removable by hand (e.g., without tools). Unpurified fluid from the filter head 102 enters cartridge 104, passes through the filter element, thereby being purified, while within cartridge 104, and then exits cartridge 104 into the filter head 102. Cartridge 104 holds the filter element that filters the fluid (or the filter cartridge 104 may be empty). When the filter element needs to be replaced, the user may replace cartridge 104. Cartridge 104 may also be referred to as a bypass plug.

In this specification, the terms “top,” “bottom,” “up,” and “down” refer to what is the top, bottom, up and down, when the filter system 100 is oriented in the orientation of FIG. 1. However, filter system 100 may be installed in any orientation, such as what would be considered sideway, upside down, etc. from the point of view of the orientation of Filter system 100 of FIG. 1.

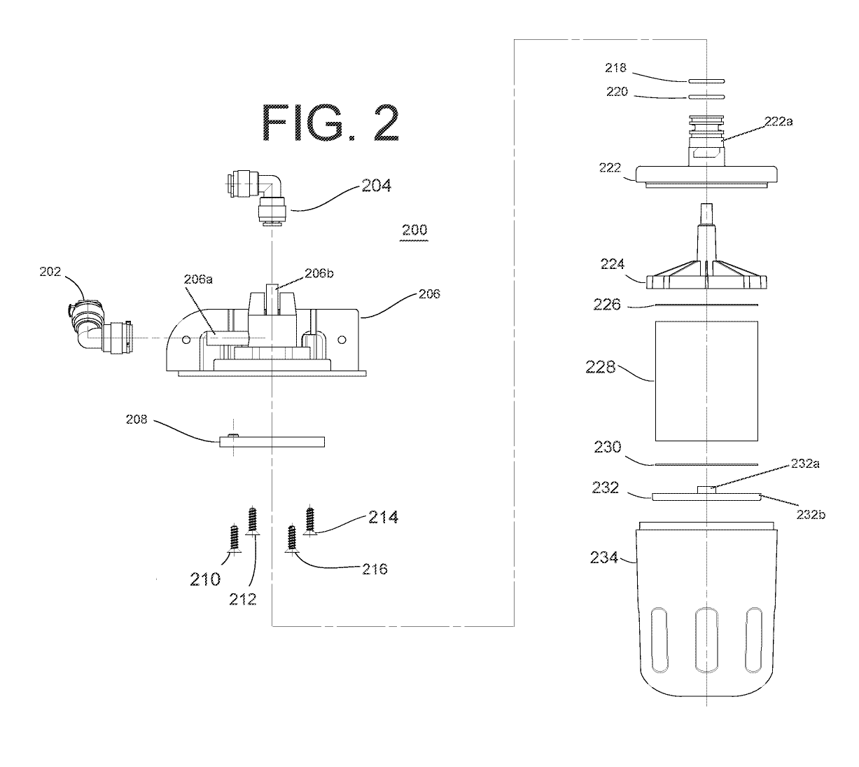

FIG. 2 shows an exploded view of an embodiment of the filter system 200. The filter system 200 includes at least input conduit 202, output conduit 204, a manifold 206 having tubular extension 206a and 206b, bottom cover 208, screws 210, 212, 214, and 216, top o-ring 218, top o-rings 220, cartridge cover 222 having neck 222a, fluid distributor 224, filter cover 226, filter element 228, filter cover 230, bottom cap 232 having tubular extension 232a and wall 232b, and canister 234. In other embodiments, the fluid filter system 200 may not include all of the components listed and/or may include other components in addition to or instead of those listed above.

Input conduit 202 connects to the input conduit of the refrigerator at one end and to the manifold of filter system 100 at another end of input conduit 202. The fluid entering input conduit 202 has been filtered by the outside filter, which has removed heavy metals from the fluid. Input conduit 202 may include a pin (or other protrusion) that automatically opens a valve on the input conduit of the refrigerator. Optionally or additionally, input conduit 202 may include a valve that automatically opens when connected to the input conduit of the refrigerator. Fluid from the input conduit of the refrigerator travels through input conduit 202 into the manifold of filter head 102 of filter system 100. Optionally, input conduit 202 may include a pin or other protrusion that automatically opens a valve on the output conduit of the refrigerator when connected to the output conduit of the refrigerator.

Output conduit 204 connects to the output conduit of the refrigerator at one end and to the manifold of filter system 100 at another end of output conduit 204. Optionally or additionally, output conduit 204 may include a valve that automatically opens when connected to the output conduit of the refrigerator. Fluid from the filter system 100 travels through output conduit 204 into the output conduit of the refrigerator.

Manifold 206 is mounted to the refrigerator. Input conduit 202 is connected to tubular extension 206a of manifold 206, and output conduit 204 is connected to tubular extension 206b of manifold 206. Fluid travels from input conduit 202 into tubular extension 206a, and then optionally into other parts of manifold 206, and into the cartridge 104 where the fluid is purified. After purification, fluid travels from cartridge 104 back into manifold 206 into tubular extension 206b of manifold 206 into output conduit 204, and then leaves filter system 104.

Bottom cover 208 attaches to the bottom of manifold 206. Cartridge 104 removably attaches to bottom cover 208. Cartridge 104 may be screwed into, or unscrewed from bottom cover 208 (e.g., while bottom cover 208 is attached to manifold 206), thereby attaching to, and detaching from, respectively, manifold 206 and filter head 102 (e.g., via a screw driver).

Screws 210, 212, 214, and 216 hold bottom cover 208 to manifold 206. Although in the embodiment of FIG. 2 there are 4 screws, in other embodiments, there may be fewer or more screws than four. For example, there may be one screw, two screws, three screws, five screws, six screws, seven screws, or eight screws. In this specification any place a screw is used, another fastener may be substituted. For example, the screws may be replaced with bolts, pegs, pins, rivets, clasps, an adherent, and/or a welded joint. The combination of input conduit 202, output conduit 204, manifold 206, bottom cover 208, and screws 210, 212, 214, and 216 form filter head 102 of filter system 100.

Top o-ring 218 is a circular loop of elastomer fitted on the neck of the filter cartridge 104 cover, optionally in first groove, at a first location on the neck of the filter cartridge 104. Top o-ring 218 provides a fluid-tight seal when the neck of filter cartridge 104 is inserted into the filter head 102 of the filter system 100. The seal between formed by top o-ring 218 between filter cartridge 104 prevents purified fluid at the entrance to output conduit 202 (and that has just exited filter cartridge 104) from leaking back into the unpurified fluid that is exiting input conduit 204 into the filter cartridge 104 and prevents unpurified fluid that is exiting input conduit 204 (and therefore about to enter filter cartridge 104) from entering output conduit 202 (and exit filter system 100) prematurely without first passing through filter cartridge 104.

Top o-ring 220 is also a circular loop of elastomer fitted on the neck of the filter cartridge 104 cover, but is located at a second location on the neck of the filter cartridge 104, optionally in second groove. Top o-ring 220 also provides a fluid-tight seal when the neck of filter cartridge 104 is inserted into the filter head 102 of the filter system 100. Top o-ring 220 prevents unpurified fluids that are exiting input conduit 204 (and that are about to enter filter cartridge 104) from leaking onto the top of the filter cartridge 104 instead of entering filter cartridge 104.

In one embodiment, the top o-rings 218 and 220 may be made of rubber, silicon, or any other soft and/or resilient fluid tight materials. In an embodiment, any of the o-rings of this specification may be made from any gummy, rubbery material, elastomer, nonporous, and/or flexible material that prevents fluids from leaking. Some non-limiting examples of materials that may be used for the O-rings are natural rubber, polyacrylate rubber, ethylene-acrylate rubber, polyester urethane, bromo isobutylene isoprene bromobutyl, polybutadiene buna, chloro isobutylene isoprene chlorobutyl, buty polychloroprene chloroprene, neoprene, chlorosulphonated polyethylene hypalon, epichlorohydrin, epichlorohydrin, epichlore, epichloridrine, herclor, hydrin, ethylene propylene, ethylene propylene diene monomer, nordel, polyether urethane, perfluorocarbon rubber, kalrez, chemraz, fluoronated hydrocarbon viton, fluorel, fluoro silicone, silicone rubber, fluorocarbon rubber, hydrogenated nitrile butadiene, polyisoprene (synthetic) natural rubber, isobutylene isoprene butyl butyl, acrylonitrile butadiene, nitrile, perbunan, buna-N, polyurethane, polyurethane, styrene butadiene, buna-S, GRS, buna VSL, buna SE, styrene ethylene butylene styrene copolymer rubber, polysiloxane silicone rubber, vinyl methyl silicone, silicone rubber, acrylonitrile butadiene carboxy monomer, carboxylated nitrile, styrene butadiene carboxy monomer, thermoplastic polyether-ester, styrene butadiene block copolymer, and/or styrene butadiene carboxy block copolymer.

Cartridge cover 222 is the cover to the filter cartridge 104. Optionally, cover 222 may be sealed to, adhered to, glued to, melted onto, screwed onto, or otherwise attached to, the top of filter cartridge 104, and the neck 222a of cartridge cover 222 may be attached to filter head 102. Top o-ring 218 and top o-ring 220 are placed on the neck 222a of cartridges cover 222 at locations above and below an opening for unpurified fluid to enter, preventing the unpurified fluid from leaking out of filter system 100, and preventing the purified fluid from mixing with the unpurified fluid.

Fluid distributor 224 distributes the incoming, unpurified fluid around the outside of the filter within the filter cartridge 104. Fluid distributor 224 has a generally cone or funnel shape with a plate shaped base. The cone of fluid distributor 224 has a neck that is inserted into the neck 222a of the cartridge cover 222. Unpurified fluid enters the cartridge cover 222 on the outside of the neck of fluid distributor 224, while purified fluid leaves the filter element through the center of the neck of filter distributor 224.

Filter cover 226 may be a flat disc with a whole in the center. Filter cover 224 covers the filter element and is located between the filter element and the bottom of the fluid distributor 224. Filter cover 224 helps prevent fluids from exiting filter element out of the flat top of the filter element, thereby helping to force the fluid to travel from the surfaces of outside walls, the filter element through the filter element and exiting the filter element through the surface of the inner walls of the filter element.

Filter element 228 is made from a material that may purify fluid, but does not remove heavy metals (instead the outside filter removes the heavy metals). In an embodiment, filter element 228 includes a hollow core into which seep from outside filter element 246, under pressure from incoming fluid. Filter element 228 filters the fluid, just after the fluid has been pumped into filter system 100 to a location in filter system 100 just outside of the filter element 228. After the fluid seeps from just outside filter element 228, through the walls of filter element 228, into the hollow core within filter element 228, the fluid from the hollow core travels, via the opening of the hollow core in the filter element 228, out of the filter element 228 into the bottom of fluid distributor 224 and up the inside of the neck of fluid distributor 224. In an embodiment, filter element 228 is cylindrical and has an opening into the hollow core and the hollow core is a cylindrical channel running through the center of the filter element 228. In an embodiment, the hollow core of filter element 228 is optionally cylindrical and is concentric with the outer surface of filter element 228. In an embodiment, filter element 228 includes an inner channel that is open on both ends, allowing more fluid to fill the hollow core and be purified by filter element 228. In other embodiments, filter element 228 could have other shapes, such as rectangular square, or spherical, and/or the opening has a different shape than the rest of the hollow core. Similarly, in another embodiment, filter element 228 may be open on only one end. In another embodiment, filter element 228 may be an element that blocks the flow in a pipe, forcing the fluids to flow through the filter element to pass through the pipe.

Filter cover 230 cover the bottom of the filter element (which is the end of the filter element that is furthest from the filter cover 222). In an embodiment, filter cover 230 is a flat disc similar to filter cover 226, which optionally has a whole in the center for engaging a protrusion in a bottom cap. Filter cover 230 covers the opposite end of filter element 228 that filter cover 226 covers, and is located between the filter element 228 and the bottom cap. Filter cover 226 helps prevent fluids from exiting filter element 228 from the flat bottom of the filter element 228, thereby helping to force the fluid to travel from the outer side walls surfaces of the filter element 228 through the filter element 228 and exiting the filter element 228 through the surface of the inner walls of the filter element 228.

In an embodiment, when cartridge 104 is assembled, the filter element 228 may be under a slight amount of pressure (e.g., slightly compressed), being slightly squeezed or snuggly fit between the filter cover 226 and a second filter cover 230 at the opposite end of filter element 228. The slight pressure that may be required to fully install the filter element 228. The slight pressure holds filter element to filter covers 226 and 228, and thereby prevents unfiltered fluid from bypassing the filter element 228 to enter the hollow core of the filter element 228.

Bottom cap 232 attaches to the bottom of filter element 228 and holds filter cover 230 to the bottom of filter cap 232. Bottom cap 232 is located at the opposite end of filter element as fluid distributor 226 and top filter cover 224. Tubular extension 232a extends up through an opening in filter cover 230 into a hollow region within filter element 228. Walls 232b extend upwards covering the sides of filter cover 230 and the top of the sides of filter element 228.

Canister 234 attaches to cartridge cover 222. Together, canister 234 and cartridge cover 222 form the housing of cartridge 104. Fluid distributor 224, filter cover 226, filter element 228, filter cover 230, and bottom cap 232 are held within canister 234 and cartridge cover 222. For example, filter cover 226, filter element 228, filter cover 230, and bottom cap 232 are located in canister 234, while fluid distributor 224 is located partially in canister 234 sticking up into cartridge cover 222. Any number of fasteners may be used to hold canister 234 to cartridge cover 222. For example, canister 234 may be welded or melted to cartridge cover 222. Canister 234 may be pressure fit and/or friction fit, to cartridge cover 224 or glued to canister cover 224. Alternatively, canister 234 may screw on to cartridge cover 222 or cartridge cover and canister cover may be held together with clasps or snaps. When canister 234 is attached to cartridge cover 222 a slight amount of pressure may be applied to press against bottom cap 232 and fluid distributor 224 into the filter element 228. Canister 234 may be just a shallow “cover” or “plug,” which may be empty, and which may be referred to as a “bypass plug,” since the filter is “bypassed” as a result of the filter not being present. The “cover,” “plug,” or “bypass plug” may be empty with nothing in the “cover,” “plug,” or “bypass plug.”

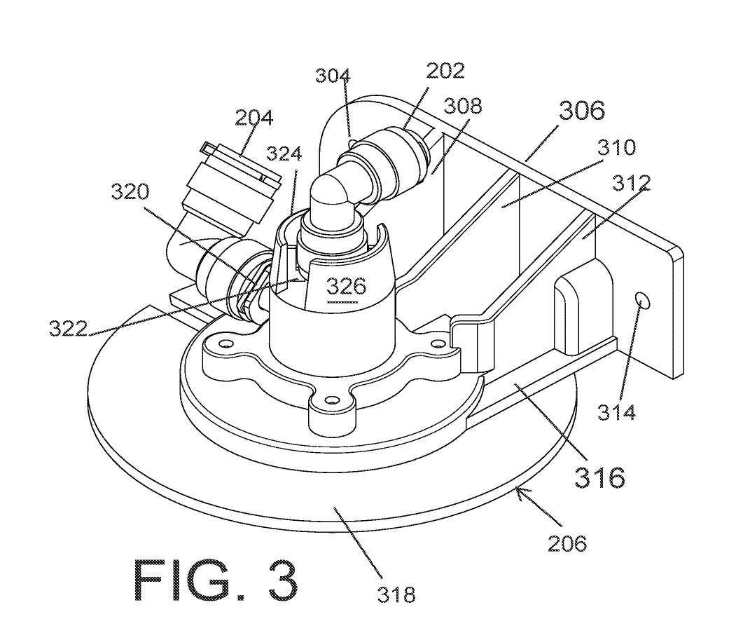

FIGS. 3-8 show details of filter head 104 and manifold 206 (which were also shown in FIGS. 1, 2, 25, and 26). However, in other embodiments, filter head 104 and/or manifold 206 may not include all of the components disclosed and/or may include other components in addition to or instead of those disclosed in conjunction with FIGS. 1-8, 25 and 26.

FIG. 3 shows an embodiment of the top of manifold 206 with input conduit 202 and output conduit 204. Manifold 206 may include hole 302, back panel 304, buttresses 306, 308 and 310, hole 314, panel 316, flange 318, connecters 302 and 322, and protective walls 324 and 326. In other embodiments, the fluid filter system manifold 206, input conduit 202 and/or output conduit 204 may not include all of the components shown in FIG. 3 and/or may include other components in addition to or instead of those listed above.

Hole 302 may accept a screw, pin, rivet or peg, and hold a back panel of the manifold 206 onto a surface within a refrigerator. Back panel 304 may be used for attaching filter system 100 to a refrigerator, thereby mounting filter system 100 on a wall within the refrigerator. Buttresses 306, 308 and 310, hold back panel 304 on the rest of the manifold 206. Hole 314 together with hole 302 accept a fastener, such as a screw, pin, peg, or rivet and hold the back panel 304 to the refrigerator. Panel 316 strengthens buttress 310. In an embodiment, panel 316 reduces the likelihood of buttress 310 (as well as buttresses 306 and 308) from flexing sideways, whereas buttresses 306, 308, and 310 reduce the likelihood of filter system 100 swaying up and down. Flange 318 may support filter system 100 on a ridge within the refrigerator. Connectors 320 and 322 connect manifold 206 to input conduit 202 and output conduit 204. Protective walls 324 and 326 protect output connector 304 from damage.

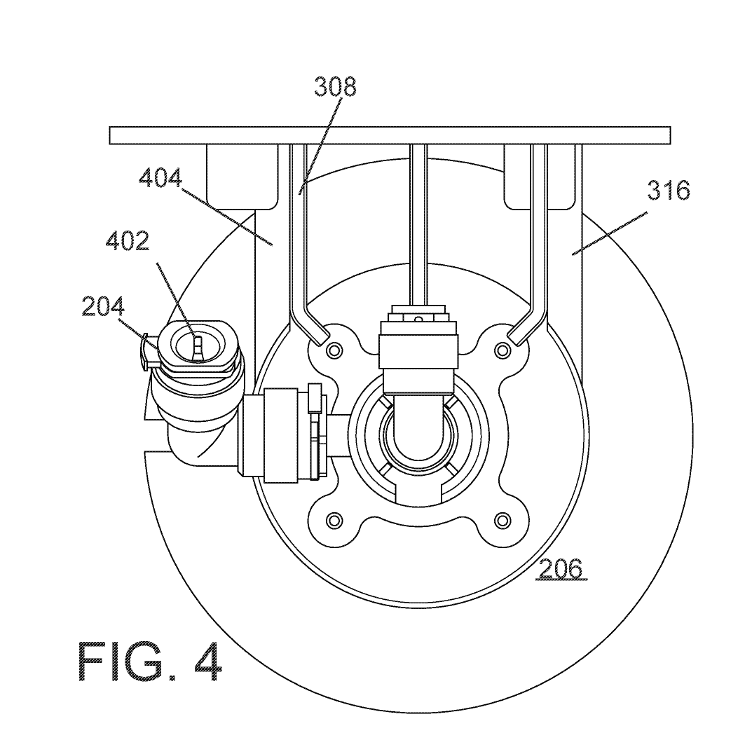

FIG. 4 shows an embodiment of a top view of manifold 206, which includes pin 402 and panel 404.

Pin 402 is connected to input conduit 204 and may open a valve on the input conduit to the refrigerator. Panel 402, similar to panel 316, stiffens manifold 206 making it more difficult for manifold 206 to sway sideways, and panel 402 is oriented perpendicularly to buttresses 306, 308, and 310 (FIG. 3). However, panel 402 is attached to buttress 306, whereas panel 316 is attached to buttress 310.

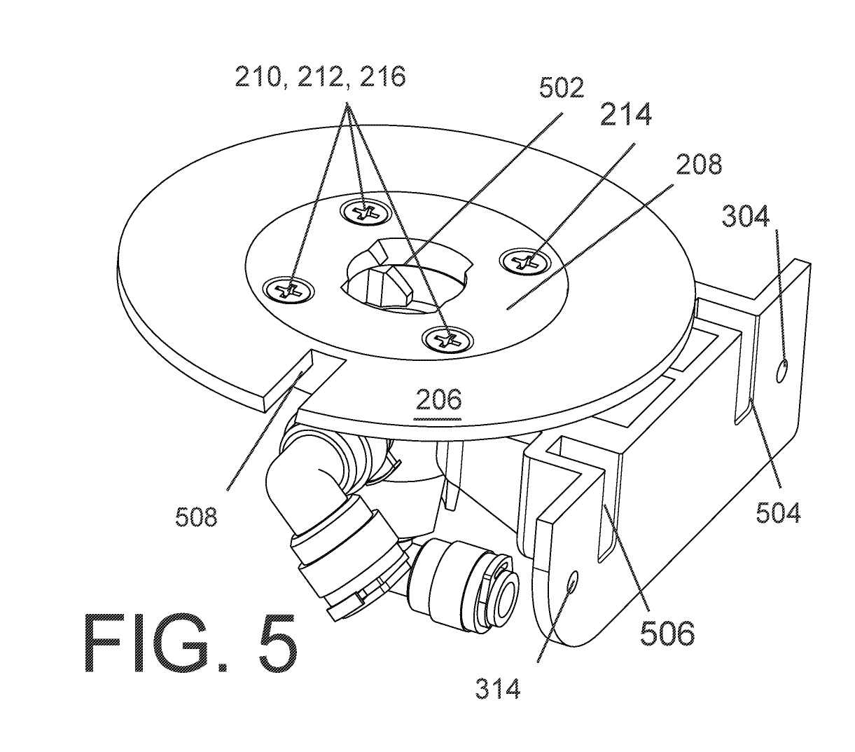

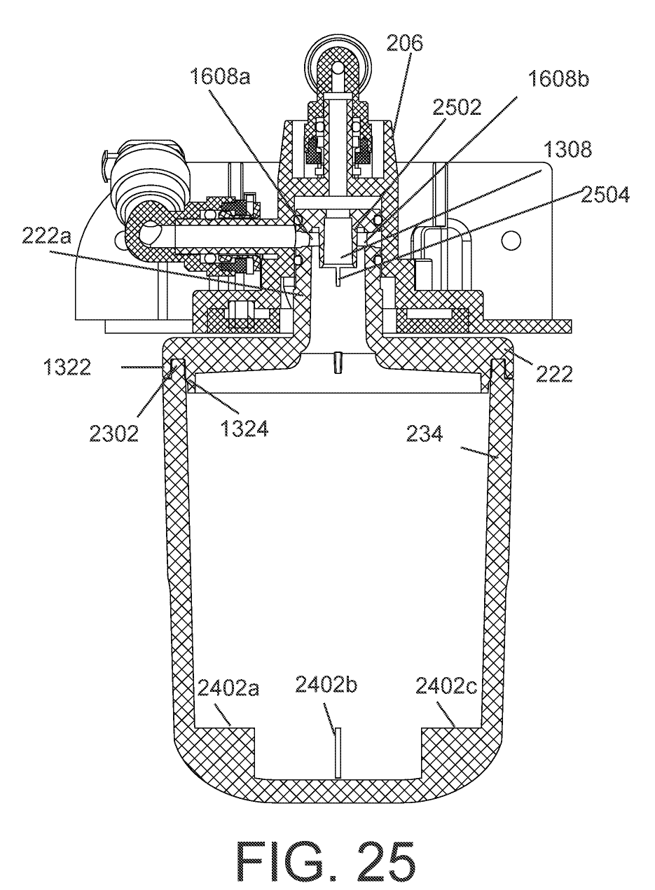

In addition to FIGS. 5-8 showing details of filter head 104 and manifold 206, FIGS. 5-11 shows details of manifold cover 208 (also shown in FIGS. 2 and 25). However, in other embodiments, manifold cover 208 may not include all of the components disclosed and/or may include other components in addition to or instead of those disclosed in conjunction with FIGS. 2, 5-8 and 25.

FIG. 5 shows a bottom perspective view of manifold 206 with manifold cover 208 attached/held on by screws 210, 212, 214, and 216. FIG. 5 also shows holes 304 and 314, opening 502, and slots 504, 506, and 508.

FIG. 5 shows a better view of hole 304 than FIG. 3. Opening 502 has a noncircular shape, and is shaped to engage protrusions on the neck of the cartridge cover 222, so that opening 502 interlocks with the neck of cartridge cover 222. In an embodiment, along one direction, the opening is wider than along another direction, so that the protrusions on the neck of the cartridge cover 222 fit through opening 502, when the protrusion point outward from the neck 222a of cartridge cover 222, pointing along the length of hole 502. Once the neck 222a of cartridge cover 222 is pushed into the manifold 206 far enough so that the protrusions passed bottom cover 208, cartridge cover 222 is rotated, so that the protrusions do not pass through bottom cover 208 and cartridge cover 222 engages bottom cover 208 and manifold 206.

Slots 504, 506, and 508 may be used to guide filter system 100 to the desired orientation and may engage protrusions or flanges attached to the refrigerator.

FIG. 6 shows the bottom side of view of manifold 206 with bottom cover 208 attached and/or held on by screws 210, 212, 214, and 216. FIG. 6 illustrates hole 502, cavity 602, and outlet passageway 604.

Cavity 602 is a cavity within manifold 206 to which input conduit 202 feeds and is connected to. Outlet passageway 604 is the channel within output conduit 204, which carries fluids within output conduit 204. Outlet passageway 604 carries fluids out of manifold 206. Cavity 602 feeds into outlet passageway 604. In other words, the passageway 604 through which fluids flow within input conduit 202 and outlet passage way 604 are connected (e.g., directly) to cavity 602. In an embodiment, the diameter of cavity 602 is smaller than the smallest diameter of hole 502, which allows the neck 222a of cartridge cover 222 to be wider at its base, which is the end of the neck that is closer to the canister 234. In an embodiment, cavity 602 is aligned with, and concentric to, hole 502 sharing the same central axis.

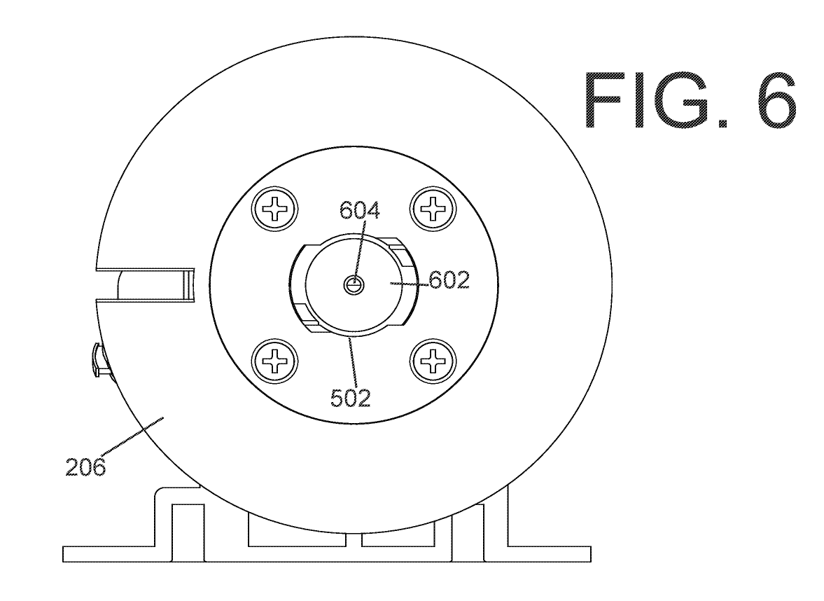

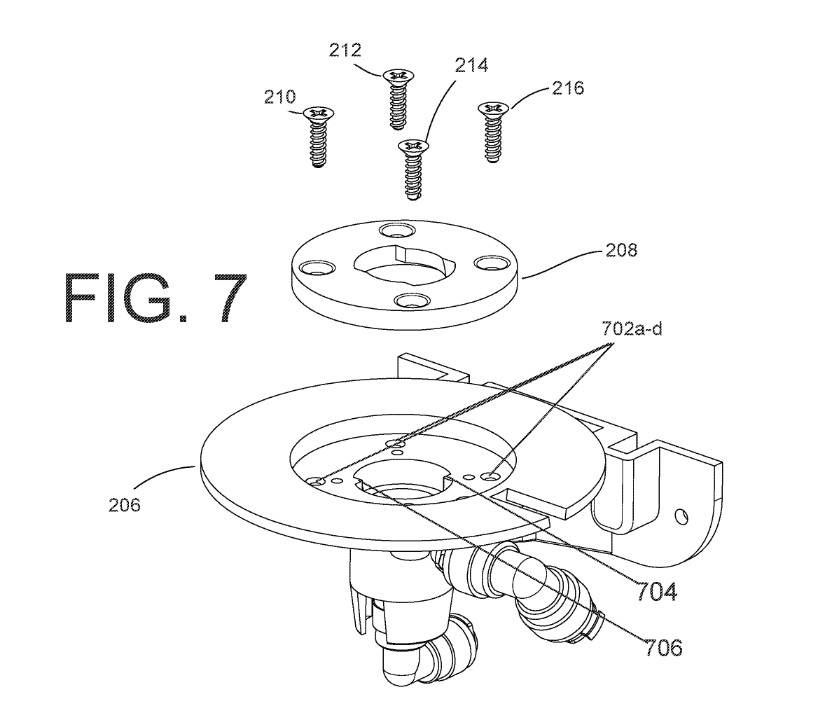

FIG. 7 shows an exploded view of manifold 206 and manifold cover 208. FIG. 7 also shows screws 210, 212, 214, and 216, holes 702a-d, and ledges 704 and 706.

Holes 702a-d align with corresponding holes in manifold cover 208. Holes 702a-d engage screws 210, 212, 214, and 216, respectively. Screws 210, 212, 214, and 216 pass through holes in manifold cover 208 to engage holes 702a-d, thereby holding manifold cover in place on the bottom of manifold 206 aligned with cavity 602. Ledges 704 and 706 are part of structures within manifold 206 that direct protrusions of the neck of cartridge cover 222, directing the rotation of cartridge 104 to interlock with manifold 206.

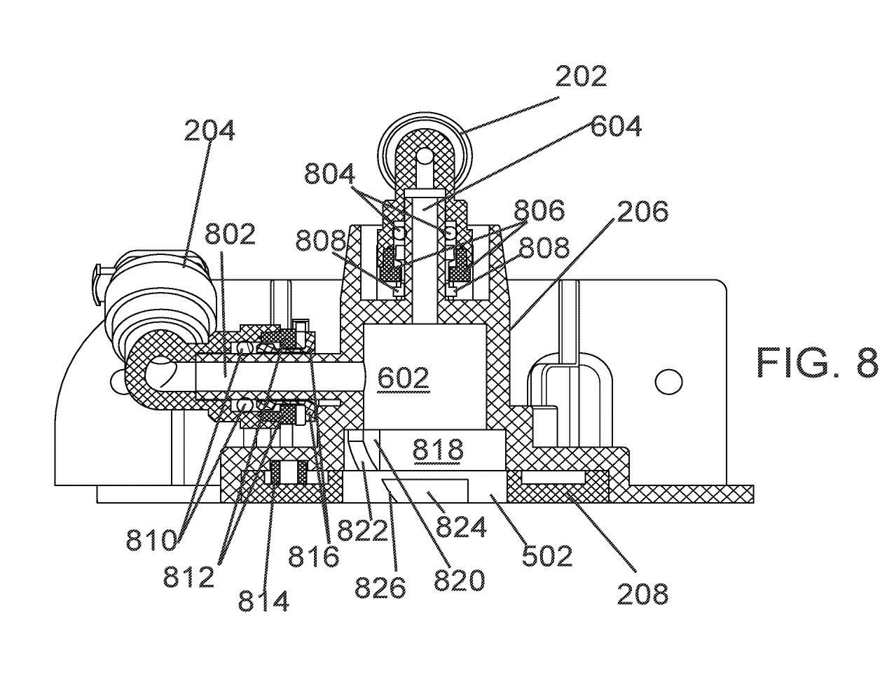

FIG. 8 shows a cross section of an embodiment of filter head 202, which shows a cross sectional view of input conduit 202, output conduit 204, manifold 206, manifold cover 208, hole 502, cavity 602, and outlet passageway 604. FIG. 8 also shows inlet passageway 802, o-ring 804, solder connection 806, collar 808, o-ring 810, ring 812, solder connection 814, collar 816, lower cavity 818, guide 820, and protrusion 822.

Inlet passageway 802 is the passageway within tubular extension 206a, which is inserted within input conduit 202, which connects to, and opens into, cavity 602. O-ring 804 maintains, or helps maintain, a fluid tight seal between manifold 206 and output conduit 204, thereby preventing leaks. Solder connection 806 may initially be an annular shaped ring that fits around tubular extension 206 out of manifold 206 into output conduit 204. Solder connection 806 is located between manifold 206 and output conduit 204. When solder connection 806 is heated, solder connection melts and then after cooling bonds to manifold 206 and output conduit 204. Collar 808 is affixed to manifold 206 and includes a depressed region within which solder connection 806 is placed. After heating and cooling, solder connection bonds directly to collar 808, thereby bonding to manifold 206.

O-ring 810 maintains or helps maintain a fluid tight seal between manifold 206 and input conduit 202, thereby preventing leaks.

Solder connection 812 may also initially be an annular shaped ring that fits around a tube extending out of manifold 206 into input conduit 202. Solder connection 812 is located between manifold 206 and input conduit 202. When solder connection 812 is heated, solder connection 812 also melts and then after cooling bonds to manifold 206 and input conduit 202. Ring 816 may engage a screw or rivet that protrudes through manifold 206, via which the filter system 100 may be attached to the refrigerator. Collar 818 is affixed to manifold 206 and includes a depressed region within which solder connection 812 is placed. After heating and cooling, solder connection 814 bonds directly to collar 818 thereby bonding to manifold 206.

Lower cavity 818 is adjacent cavity 602, between cavity 602 and an opening on the bottom of manifold 206, and is between manifold cover 208 and cavity 602. In an embodiment, lower cavity 818 accepts protrusions on the neck 222a of cartridge cover 222. Guide 820 guides (or helps guide) the protrusions of the neck of cartridge cover 222 to a desired location within lower cavity 818. Optionally, one side of guide 820 may be sloped and optionally rounded. Guide 820 guides the neck of cartridge 222 to turn in a desired direction. Slope 822 is the slope of guide 820 (which is optionally rounded). One end of the slope 822 may be closer to manifold cover 222 and further from cavity 602, and another end of slope 822 may be further from manifold cover 208 and closer to cavity 602. Protrusion 824 is part of manifold cover 208 and may have a similar shape as guide 820. Protrusion 824 may guide the neck of cartridge 222 (and therefore the entire cartridge 104) to rotate the same direction as guided by guide 820. Slope 826 is the slope that is on protrusion 824. Slope 826 may have a similar shape as slope 822. One end of slope 826 may be closer to guide 820 and further from the opening of manifold 206. Another end of slope 826 may be further from guide 820 and closer to the opening of manifold 206. The end of slope 826 that is closer to guide 820 is also located adjacent to (or closer to) the end of slope 822 that is closer to the opening of manifold 206 (than to the end of slope 820 that is closer to cavity 602). One of ledges 704 and 706 may be part of guide 820, and another guide (not shown) may form the other of ledges 704 and 706.

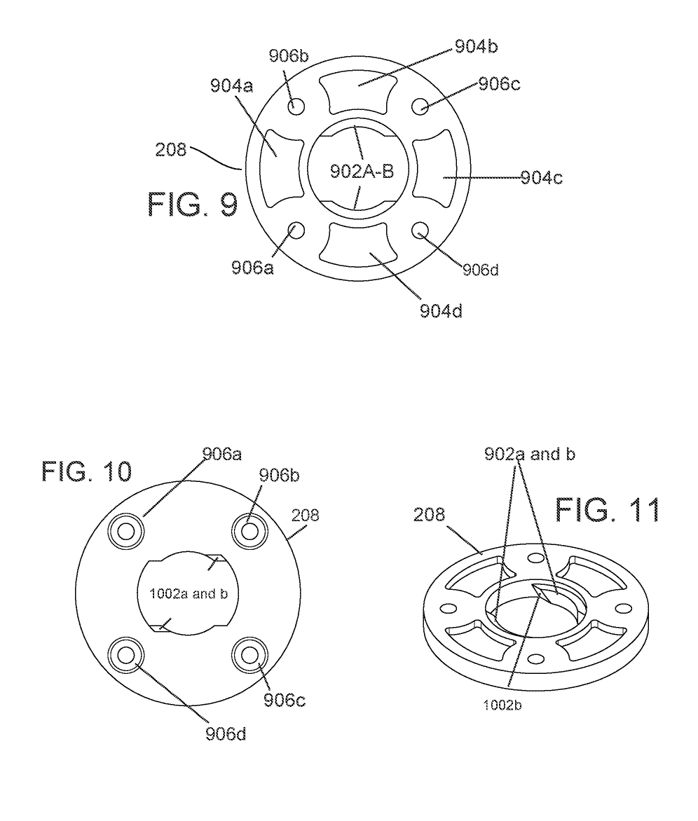

FIG. 9 shows a top view of the manifold cover 208, which is the side of the manifold cover 208 that faces manifold 206 when manifold cover 208 is connected to the manifold 206. FIG. 9 shows protrusions 902a-b, depressions 904a, 904b, 904c, and 904d, and screw holes 906a, 906b, 906c, and 906d.

Protrusions 902a-b may be embodiments of protrusion 824. Depressions 904a, 904b, 904c, and 904d form a cavity in combination of with a surface of manifold 206 that faces manifold cover 208, within which one or more rings 814. Screws 210, 212, 214, and 216 pass through screw holes 906a, 906b, 906c, and 906d to engage holes 702a-d (FIG. 7), thereby holding manifold cover in place on the bottom of manifold 206 aligned with cavity 602.

FIG. 10 shows a top view of manifold cover 208, which shows screw holes 906a-d, and slopes 1002a and b.

The top view of FIG. 10 is the side of the manifold cover 208 that faces away from the manifold 206. FIG. 10 shows that screw holes 906a-d may optionally include a depression surrounding the screw hole itself for receiving the head of the screw (or rivet or other fastener). Slopes 1002a and b are embodiments of slope 826. Slopes 1002a and b are a portion of protrusions 902a and b within manifold cover 208 that are visible when looking at the top view of cover 208.

FIG. 11 shows a perspective view of the top sides of manifold cover 208, which shows a perspective view of protrusions 902a and b and slope 1002b.

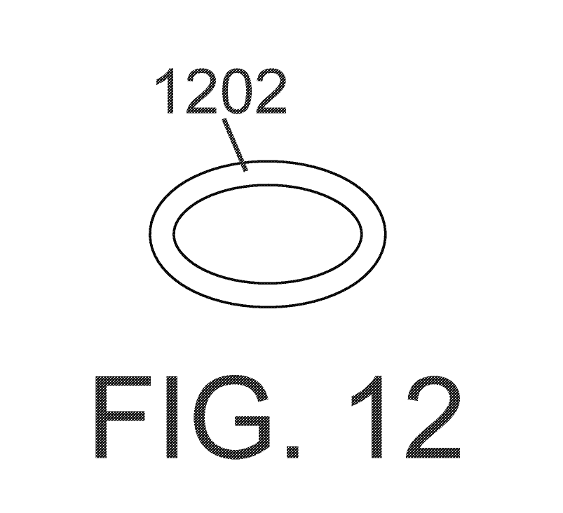

FIG. 12 shows a perspective view of o-ring 1202, which may be an embodiment of any combination of, or all of, o-rings 218, 220, 804 and/or 810. O-ring 1202 may be donut shaped, for example, have a circular cross section. In other embodiments, o-ring 1202 may have another cross-sectional shape, such as ovular, square, rectangular, triangular, for example. In other embodiments, the o-ring 1202 may not include all of the components listed and/or may include other components in addition to or instead of those listed above.

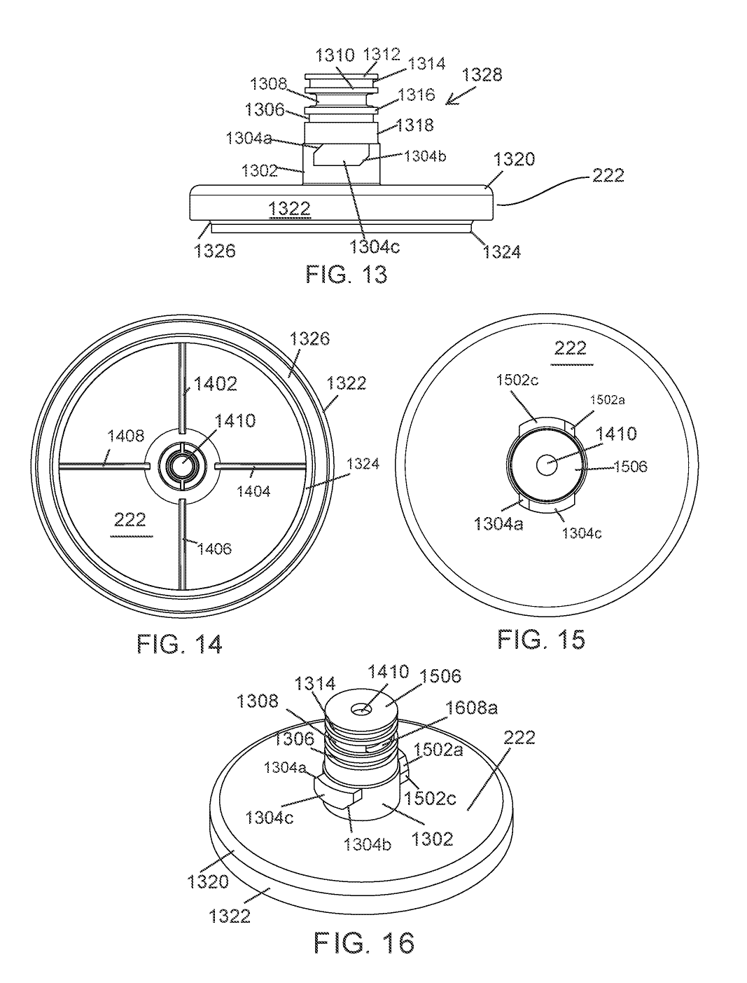

FIGS. 13-16 show details of cartridge cover 222 (which is also shown in FIGS. 2, 25 and 26). However, in other embodiments, cartridge cover 222 may not include all of the components disclosed and/or may include other components in addition to or instead of those disclosed in conjunction with FIGS. 2, 13-16, 25 and 26.

FIG. 13 shows a side view of an embodiment of cartridge cover 222, which may include neck base 1302, slope 1304a, slope 1304b, protrusion 1304c, groove 1306, channel 1308, rim 1310, rim 1312, groove 1314, rim 1316, neck portion 1318, beveled portion 1320, wall 1322, wall 1324, optional sloped portion 1326, and neck 222a.

Neck base 1302 is the base of the neck of cartridge cover 222. Slope 1304a is an upper slope of the protrusion on the neck base 1302. Slope 1304b is an upper slope of the protrusion on the neck base 1302. Protrusion 1304c is an embodiment of a protrusion on the neck of cartridge 222, which is located on neck base 1302. Slopes 1304a and b are located on protrusion 1304c. Slopes 1304a and 1304b may be parallel to one another. Slope 1304a faces in the direction of flow of the outgoing fluid and faces manifold 206, whereas slope 1304b faces canister 234. Slope 1304a is at one end of protrusion 1304c (e.g., the left end of protrusion 1304c of FIG. 13), and slope 1304b is at another end of protrusion 1304c (e.g., the right end of protrusion 1304c of FIG. 13). Slope 1304a guides the neck of cartridge 104 as cartridge 104 is rotated (e.g., clockwise) and pushed into manifold 206, whereas slope 1304b guides the neck of cartridge 104 as cartridge 104 is rotated (e.g., counter clockwise) and pulled out of manifold 206.

Groove 1306 holds o-ring 220 in place. Channel 1308 receives fluid from input conduit 204, where the fluid enters cartridge cover 222. Rim 1310 and rim 1312 form groove 1314, which holds o-ring 218. Similarly, rim 1316 and neck portion 1318 for groove 1306 (which holds o-ring 220). In an embodiment, neck portion 1318 has a smaller radius than neck base 1302. Beveled portion 1320 may be a rounded or beveled portion of manifold cover 222. Wall 1322 is a wall that is at the edge and rim of cartridge cover 222 and extends over a rim of canister 104. Wall 1324 is a wall that is near the edge and rim of cartridge cover 222 and extends into canister 104. Wall 1324 may be concentric to, and has a smaller diameter than, wall 1322.

Sloped portion 1326 may help guide cartridge cover 222 onto canister 234.

Neck 222a (see also FIG. 2) is the neck of cartridge cover 222, which may include neck base 1302, groove 1306, channel 1308, rim 1310, rim 1312, groove 1314, rim 1316, and neck portion 1318.

FIG. 14, shows a bottom view of cartridge cover 222, which may include wall 1322, wall 1324, sloped portion 1326, struts 1402, 1404, 1406, and 1408, and hole 1410. Struts 1402, 1404, 1406, and 1408 strengthen wall 1324. Hole 1410 allows fluid to leave cartridge 206.

FIG. 15 shows a top view of cartridge cover 222 having slope 1304a on protrusion 1304c and hole 1410. FIG. 15 also shows slope 1502a on protrusion 1502c and top of neck 1506. In an embodiment, protrusion 1502c and slope 1502a have the same shape as protrusion 1304c and slope 1304a. Top of neck 1506 is the top of neck 222a, which faces manifold 206.

FIG. 16 shows neck base 1302, slope 1304a and 1304b, which are on protrusion 1304c, groove 1306, channel 1308 (see FIG. 13), groove 1314, hole 1410 (see FIG. 14), slope 1502a on protrusion 1502c, top 1506 (see FIG. 15) and opening 1602. Opening 1602 is an opening in channel 1308. Fluids from input conduit 204 flows into channel 1308 and then into opening 1602 for filtering.

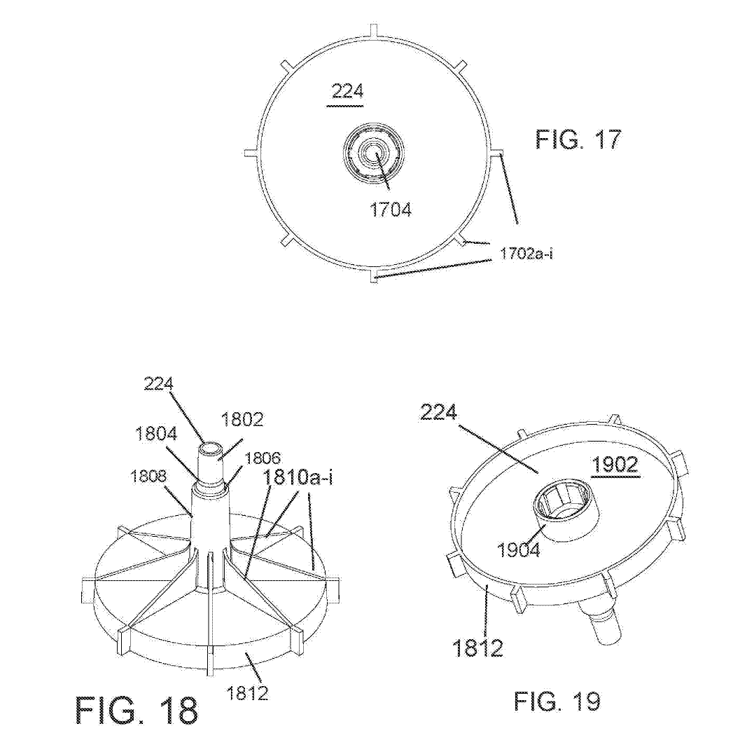

FIGS. 17-19 shows details of fluid distributor 224 (which is also shown in FIG. 2). However, in other embodiments, fluid distributor 224 may not include all of the components disclosed and/or may include other components in addition to or instead of those disclosed in conjunction with FIGS. 2 and 17-19.

FIG. 17 shows a bottom view of fluid distributor 224, which includes conduit 1702 and spacers 1704a-i. Fluid flows out of the filter element 224 into conduit 1704 and then into manifold 206. Spacers 1704a-i keep a space between the inner walls of the canister 234 and the fluid distributor 224, so that incoming fluid can flow down the outer sides of fluid distributor 224 into the canister 234 to pass through the outer walls of filter element 228.

FIG. 18 shows a perspective view of fluid distributor 224 from the top of fluid distributor 224, which includes nose 1802, optional o-ring 1804, optional o-ring 1806, neck 1808, spacers 1810a-i, and wall 1812.

Nose 1802 engages the top inner portion of neck 222a and extends at least to the top of neck 222a. Optional o-ring 1804 and optional o-ring 1806 are located around the point where nose 1802 joins the rest of the neck of fluid distributor 224, and helps keep fluids leaving the fluid distributor 224 from flowing down the sides of fluid distributor 224. Neck 1808 is wider than nose 1802 and supports nose 1802. Spacers 1810a-i keep a space between cartridge 222 and fluid distributor 224, so that incoming fluid flows down the sides of fluid distributor 224. Wall 1812 extends over the sides of filter element 228 and filter cover 226 and holds filter cover 226 in place on top of filter element 228.

FIG. 19 shows a perspective view of fluid distributor 224 from the bottom of fluid distributor 224, which shows under surface 1902 and tubular protrusion 1904. Surface 1902 is a smooth flat surface that faces filter cover 226 and contacts filter cover 226 when fluid distributor 224 and the filter cartridge 228 are installed in canister 234. Tubular protrusion 1904 is the beginning of the conduit 1704, and tubular protrusion 1904 is inserted into the hollow cavity of filter element 228 to aid in holding filter element 228 and filter distributor 224 in alignment.

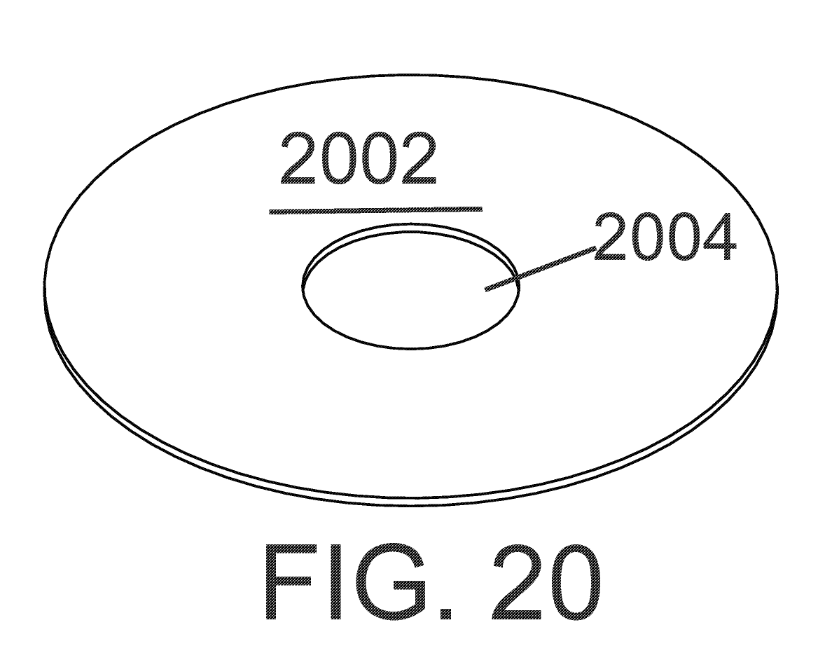

FIG. 20 shows a perspective view of filter cover 2002. In other embodiments, the filter cover 2002 may not include all of the components disclosed in FIG. 20 and/or may include other components in addition to, or instead of, those disclosed in FIG. 20.

Filter cover 2002 may be an embodiment of filter covers 226 and 230. Filter cover 2002 may look the same from the top and the bottom and may be a simple disc with a hole in the center. Filter cover 2002 may have the same shape as the top and/or bottom of the filter element (e.g., circular), so as to cover the top and/or bottom filter element 228.

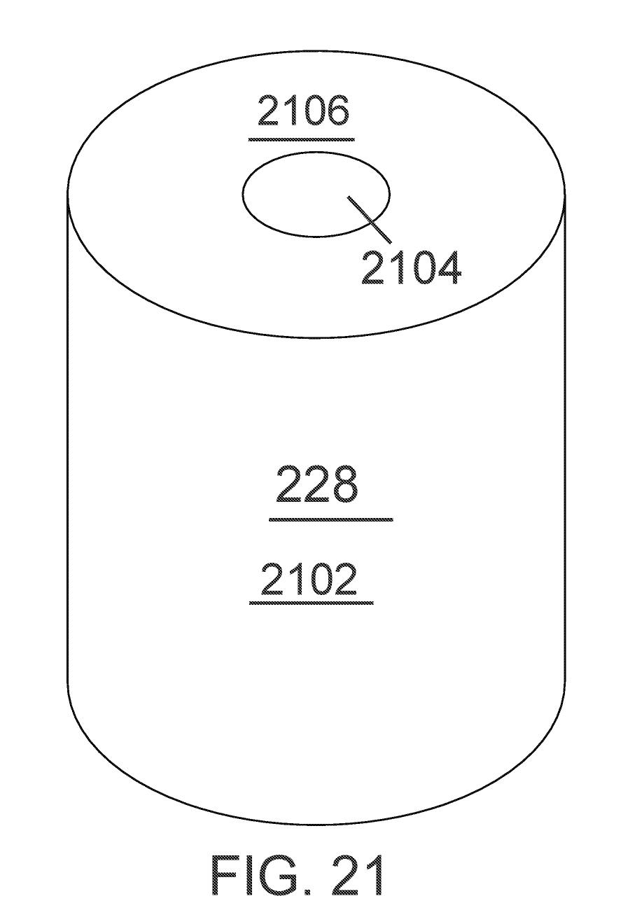

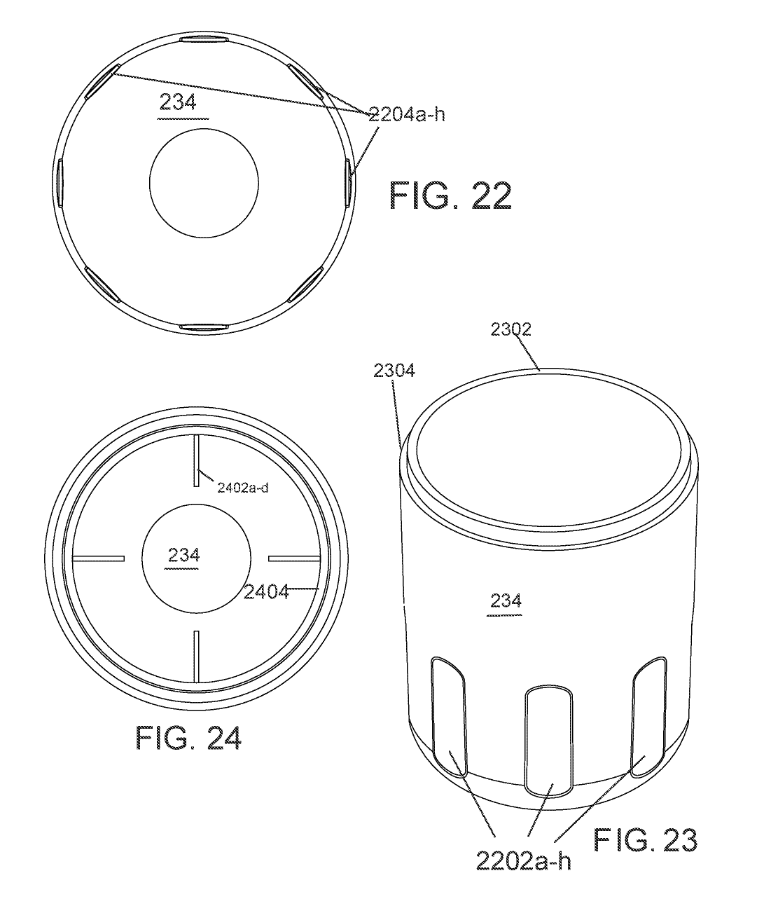

FIG. 21 shows filter element 228 includes outer side wall 2102, cavity 2104, and top 2106. In the embodiment of FIG. 21, filter element 228 is cylindrical. Outer side wall 2102 is the outer wall of the filter element 228. Unfiltered fluid enters filter element 228 and is filtered as the fluid passes through filter element 222. Cavity 2104 is a hollow cavity in filter element 228 (e.g., at the core of filter element 228) where filtered fluid gathers after having passed through filter element 228. Cavity 2104 may also be referred to as the core, or hollow core, of filter element 228. The term cavity and hollow core may be substituted for one another throughout this specification to obtain different embodiments. Tubular protrusion 1904 is inserted into cavity 2104 to keep filter element 228, filter cover 226, and filter distributer 224 aligned. In an embodiment, the diameter of cavity 2104 is the same as the inner diameter of filter cover 226, which are both slightly larger than the diameter tubular protrusion 1904. In an embodiment, cavity 2104 is cylindrical and concentric with the outer wall side wall 2102. Top 2106 is the top of filter element 228. In an embodiment, top 2104 is flat and the bottom of filter element 228 is identical to the bottom of filter element 228. When cartridge 104 is assembled, top 2106 and the bottom of filter element 228 are covered with filter covers 226 and 230, respectively, preventing fluid from exiting filter element via top 2104 and the bottom of filter element 228.

FIGS. 22-24 show details of an embodiment of canister 234 (which can also be seen in FIGS. 1, 2, 25 and 26). However, in other embodiments, fluid distributor 224 may not include all of the components disclosed and/or may include other components in addition to or instead of those disclosed in conjunction with FIGS. 1, 2, and 22-26.

FIG. 22 shows a bottom view of canister 234. Canister 234 may include indentations 2204a-h, which are optional, and may be a plurality of grooves around the outside perimeter of the canister 234, which form a grip for the user to grab filter canister 234 when installing or uninstalling cartridge 104. In an embodiment, the indentations 2204a-h extend from the bottom edge of the canister 234 toward the neck 222a (FIG. 13). The indentations 2204a-h facilitate grasping and/or gripping the filter unit 120 and/or may be for decoration purposes. In the embodiment in FIG. 1, indentations 2204a-h have a cross sectional shape that is a section of a circle (e.g., an eighth of a circle) and optionally has a partly spherical top end. Indentations 2204a-h, if present, may have any of a number of shapes, such as having a cross section that is elliptical, ovular, rectangular, triangular, and/or polygonal. Similarly, the perimeter of the canister 234 may include protrusions in addition to, or instead of, indentations 2204a-h.

FIG. 23 shows a perspective view of canister 234, which shows another view of indentations 2204a-h. Canister 234 may include lip 2302 and wall 2304. Canister 234 may be cylindrical in shape and hollow on the inside and shaped to hold filter element 226 in place, within canister 234.

Lip 2302 rises above wall 2304 of canister 234. Lip 2302 may engage cartridge cover 222 to aid in forming a seal. In this specification, any part that is intended to form a seal with an o-ring or another component, so that fluids will not leak, may be made from a nonporous material, such as plastic or metal. Some non-limiting examples of nonporous plastics that may be used for wall 1322, wall 1324, lip 2302, and/or other components used for creating a seal are Polyethylene Terephthalate (PET), High-Density Polyethylene (HDPE), Acrylonitrile Butadiene Styrene (ABS), Polyvinyl Chloride (PVC) or Polypropylene (PP).

FIG. 24 shows a top view of canister 234, which shows the inside of canister 234 and includes supports 2402 and ledge 2404. Supports 2402 and 2404 are optional. Supports 2402 may be flanges. Supports 2402 and ledges 2404 extend below and support cap 232. Only one of supports 2204 and ledge 2404 are needed to support cap 232. Although four supports 2402 are shown, and number of flanges may be used. In an alternative embodiment, cap 232 may lay at the bottom of canister 234, without supports 2402 and ledge 2404.

FIG. 25 shows a cross sectional view of filter system 100 having filter cartridge 104 attached to manifold 206. FIG. 25 shows neck 222a having openings 1608a and 1608b, openings 1608a and 1608b face away from one another, and allow fluid from input conduit 204 to enter filter cartridge 104. Neck 222a extends into and fits snuggly within the bottom of manifold 206. Lip 2302 fits snuggly between walls 1322 and 1324. Lip 2302 and walls 1322 and 1324 are sealed to one another to prevent fluid from leaking. Channel 1308 is located in a tubular portion 2502 in the top portion of neck 222a. Nose 1802 of fluid distributor 224 is inserted into channel 1308 of tubular portion 2502 through which fluid partially purified by filter element 228 flows. Tubular portion 2502 is optionally supported by flange 2504. FIG. 25 shows filter cartridge 104 without fluid distributor 224, filter cover 226, filter element 228, filter cover 230 and cap 323. Fluid distributor 224, filter cover 226, filter element 228, filter cover 230 and cap 323 are optional, because the outer filter will filter the fluid. When fluid distributor 224, filter cover 226, filter element 228, filter cover 230 and cap 323 are not present, canister 234 fills up with fluid, and once full, fluid enters entrances 1608a and/or 1608b and then exits through channel 1308 (without being filtered).

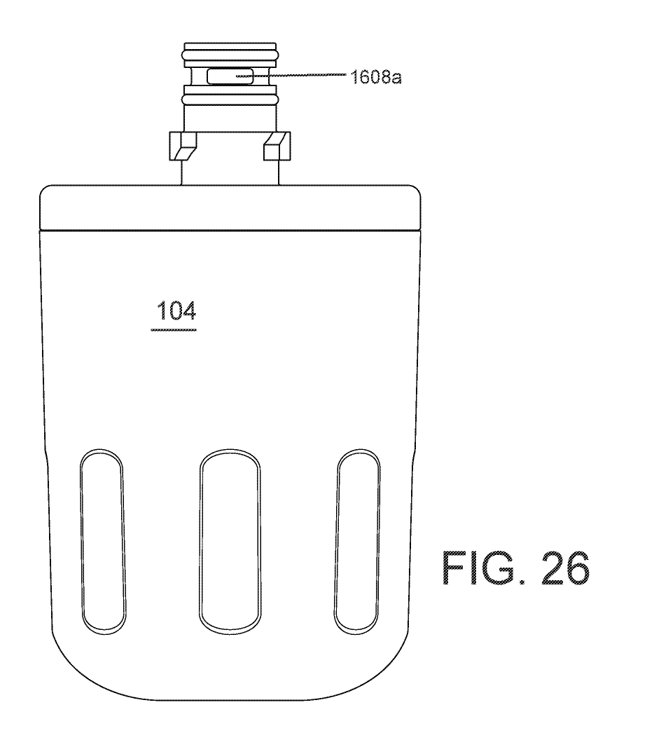

FIG. 26 shows a front view of filter cartridge 104, which shows the shape of one embodiment of opening 1608a, which may be the same as the shape of opening 1608b.

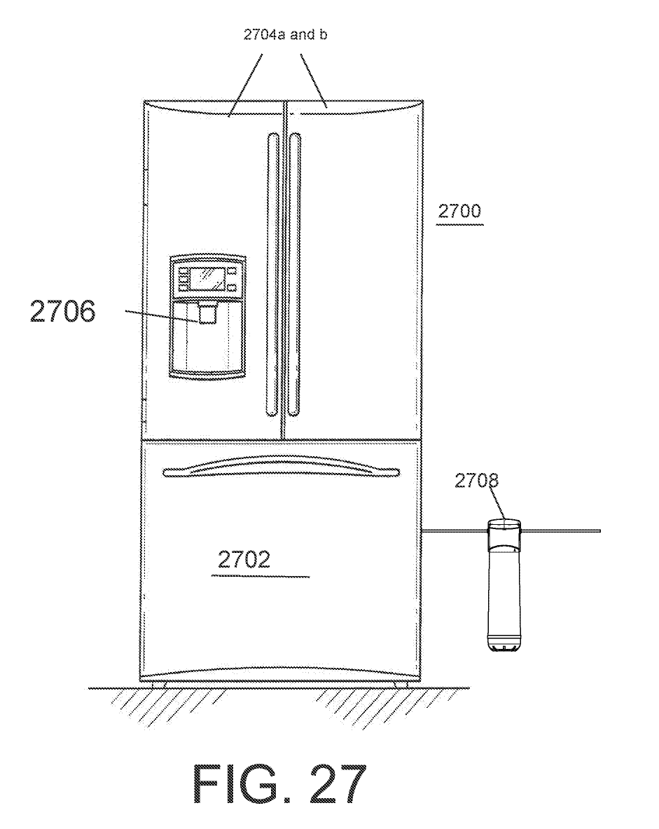

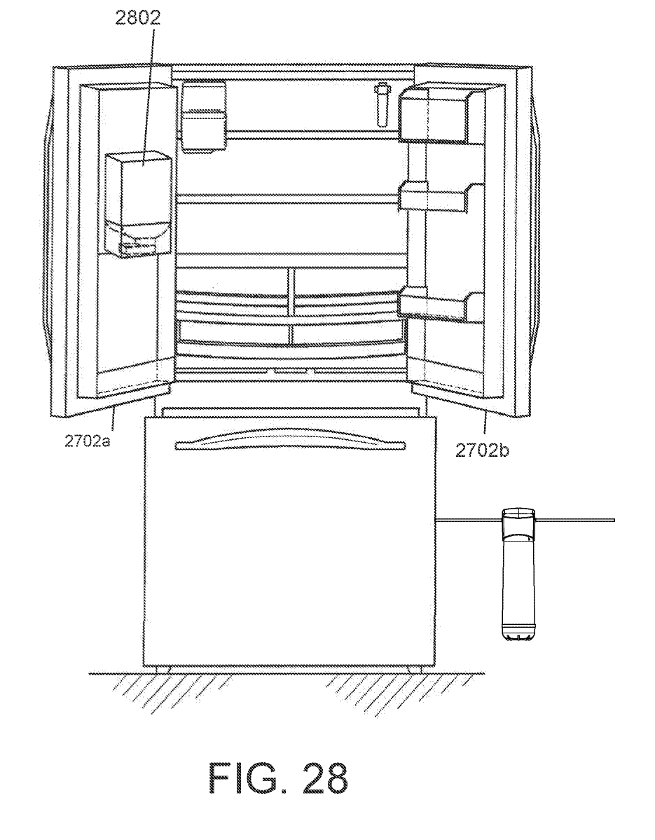

FIGS. 27 and 28 show refrigerator filter system 2700 having refrigerator 2702, doors 2704a and b, water dispenser 2706, and outside filter 2708. In other embodiments, refrigerator filter system 2700 may not include all of the components disclosed in FIGS. 27 and 28 and/or may include other components in addition to or instead of those disclosed in FIGS. 27 and 28.

In the embodiment of FIG. 27, water dispenser 2706 is installed in door 2704a, which dispense water from filter system 104 (FIG. 1). Water from output conduit 204 (FIG. 2) is dispensed via water dispenser 2706. In other embodiments, filter system 100 may be installed elsewhere in refrigerator 2700 (e.g., door 2702b). Outside filter 2708 receives water from a water source (e.g., via hoses, pipes, or other conduits) and is attached to refrigerator 2700 (e.g., also via hoses, pipes, or other conduits). Outside filter 2708 filters water entering refrigerator 2700 and is therefore attached (e.g., indirectly) to input conduit 202 (FIG. 2).

FIG. 28 shows refrigerator filter system 2700 with doors 2704a and b opened. In the embodiment of FIG. 28, filter system 100 is installed on the inside of door 2704a near water dispenser 2706.

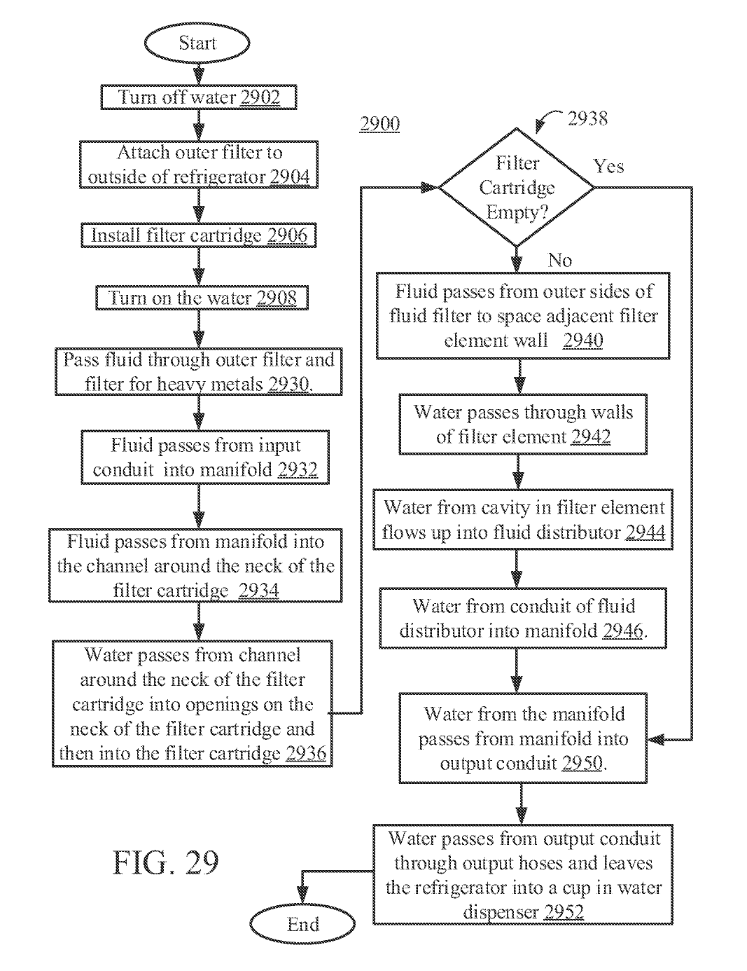

The fluid filter system mentioned in FIGS. 29-31 may be any of the embodiments of the fluid filter systems in this specification.

### Method of Use

FIG. 29 is a flowchart of an embodiment of a method 2900 of using the fluid filter system 2700.

In step 2902, water is turned off.

In step 2904, outer filter 2708 is attached to the input water hose of filter system 2700 (if outer filter 2708 has not been constructed, outer filter 2708 is first constructed).

In step 2906, filter cartridge 104 installed onto filter head 102 of filter system 100 (at any time prior to step 2906, if filter head has not been constructed yet and/or has not been installed in refrigerator 2702, filter head 102 is constructed and/or installed, and if filter cartridge 104 is not constructed yet, filter cartridge 104 is constructed). Filter cartridge 104 may be installed with or without fluid distributor 224, filter cover 226, filter element 228, filter cover 230 and cap 323. Steps 2904 and 2906 may be performed in any order.

In step 2908, the water is turned on and the water dispenser is activated (if the filter head 104 has an automatic shutoff valve, the water does not necessarily need to be turned off).

In step 2930, fluid passes through outer filter 2708 and is filtered for heavy metals. In step 2932, the filtered water then passes into refrigerator 2702 to input conduit 202.

In step 2932, the fluid passes into filter head 102, through input conduit 202, and from input conduit 202 into manifold 206 (e.g., into tubular extension 206a).

In step 2934, in an embodiment, while in manifold 202 the fluid passes through input tubular extension 206a, and then fluid flows from manifold 202 into channel 1308, which is around the neck of the filter cartridge 104.

In step 2936, the water in channel 1308 passes through openings 1608a and/or 1608b into filter cartridge 104.

As indicated by decision box 2938, if fluid distributor 224, filter cover 226, filter element 228, filter cover 230 and cap 323 are present, then the method proceeds to step 2940. In an embodiment, the decision of decision box 2938 occurs automatically as a direct result of whether filter cartridge 104 is empty or fluid distributor 224, filter cover 226, filter element 228, filter cover 230 and cap 323 are present.

In step 2940, the water flows down the outer sides of fluid distributor 224 into canister 234 poised to pass through filter element 228. For example, the water flows to a location outside of filter element 228 that is just outside of outer wall 2102 of the filter element 228.

In step 2942, the water under the pressure of the incoming water passes through filter element 228 and is filtered. In an embodiment, the water passes through filter element 228 and fills cavity 2104. In an embodiment, as part of step 2942, filter covers 226 and 230 keep fluid from exiting filter element 228 out of the top or bottom before reaching the cavity 2104, where filter covers 226 and 230 are held in place by fluid distributor 224 and cap 232 (which in turn are held together by canister 234 and cartridge cover 236).

In step 2944, when the water height is high enough, water from cavity 2104 flows into and up conduit 1308 of fluid distributor 224. When the water is first turned on, the water may need to fill cavity 2104 before any water can enter conduit 1308. After filter system 100 has already been used, cavity 2104 may already be full, and water immediately upon turning on the water, some water travels from cavity 2104 into conduit 1308.

In step 2946, water from conduit 1308 enters manifold 206 (e.g., by entering tubular extension 206b).

Returning to decision box 2938, if filter cartridge 104 is empty (e.g., if fluid distributor 224, filter cover 226, filter element 228, filter cover 230 and cap 323 are not present), then the method skips step 2940-2946, and the method proceeds to step 2948, where, if the filter system 100 is being used for the first time after being installed and turning on the water, the water may fill canister 234. Once canister 234 is full, water flows from canister 234 into filter head 102 (e.g., and the water flows up tubular extension 206b). If the filter system 100 was previously used, canister 234 may already be full, and water may start flowing from canister 234 into filter head 102.

In step 2950, water from manifold 206 (e.g., form tubular extension passes from tubular extension 206b) and flows into output conduit 204. In step 2952, water passes from filter head 104 (e.g., from output conduit 204) through output hoses and leaves the refrigerator 2702 (e.g., into a cup in the water dispenser 2706).

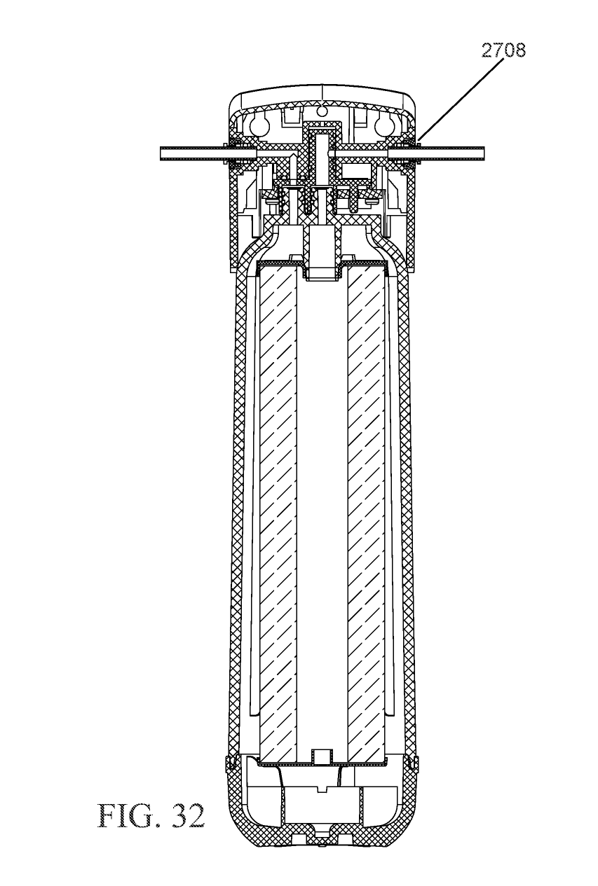

FIG. 32 shows the cross sectional view of the outside filter 2708 of FIG. 27. In an embodiment, the filter element 2708 is effective in filtering out of drinking water cadmium, mercury, lead, and/or arsenic optionally to safe levels. Additionally, or alternatively, in an embodiment, the filter element 2708 is effective in filtering out of drinking water beryllium, aluminum, chromium, manganese, iron, cobalt, nickel, copper, zinc, arsenic, selenium, molybdenum, silver, cadmium, tin, antimony, barium, mercury, thallium, and/or lead optionally to safe drinking levels.

In an embodiment, each of the steps of method 2900 is a distinct step. In another embodiment, although depicted as distinct steps in FIG. 9, steps 2902-2952 may not be distinct steps. In other embodiments, method 900 may not have all of the above steps and/or may have other steps in addition to or instead of those listed above. The steps of method 2900 may be performed in another order. Subsets of the steps listed above as part of method 2900 may be used to form their own method.

### Method of Assembly of Filter Cartridge

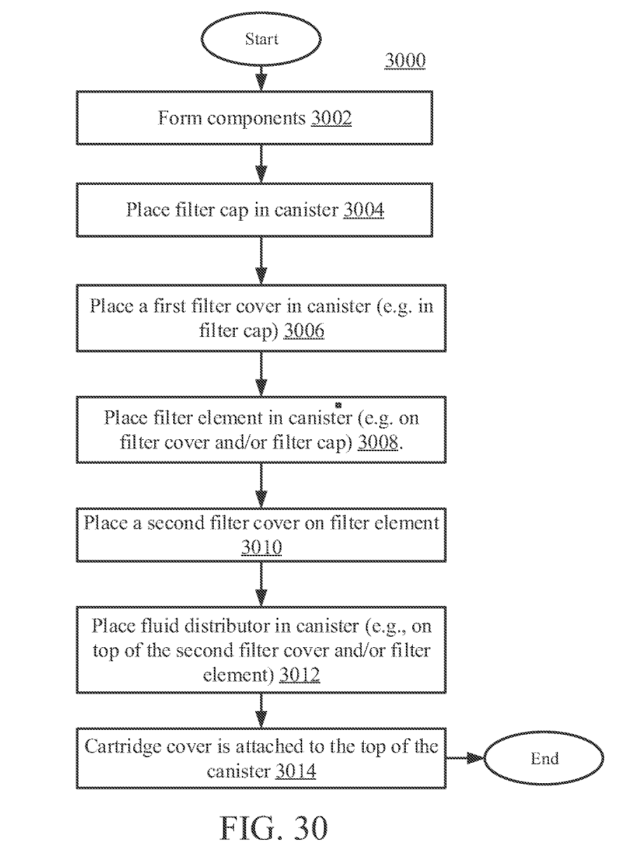

FIG. 30 is a flowchart of an embodiment of a method 3000 of making the fluid cartridge 104.

In step 3002, filter cap 232, canister 234, filter cover 230, filter element 228, filter cover 226, fluid distributor 224, cartridge cover 222, o-ring 220, and o-ring 218 (FIG. 2) are formed.

In step 3004, the filter cap 232 is placed in canister 234, and optionally is placed on supports 2402a-d and/or ledge 2404 (FIG. 24). In step 3006, filter cover 230 is placed in filter cap 232, and optionally filter cover 230 is placed in a location such that hole 2004 (FIG. 20) in the middle of filter cover 230 engages tubular extension 232a, so that tubular extension 232a protrudes through hole 2004. In step 3008, filter element 228 is placed on filter cover 230, and optionally tubular extension 232a protrudes into cavity 2104. In step 3010, filter cover 226 is installed, such as by placing filter cover 226 on top surface 2106 of filter element 228, with hole 2004 aligned with the opening to cavity 2104 (FIG. 21). In step 3012, fluid distributor 224 is placed on top of filter cover 226, such that tubular extension 1904 extends through and engage hole 2004 of filter cover 226 and cavity 2104 and wall 1812 (FIG. 18) of fluid distributor 224 extends over the side 2102 of filter element 228, thereby engaging filter element 228. As part of step 3012, spacers 1702a-i (FIG. 17) are placed within canister 234, maintain a distance between fluid distributor 224 and the inner wall of canister 234. In step 3014, cartridge cover 222 is placed on top of canister 234 and sealed. As part of step 3014, lip 2302 of canister 234 is placed between walls 1322 and 1324 (FIG. 13), and sealed together. As part of step 3014, nose 1802 (FIG. 18) is inserted into tubular portion 2502 (FIG. 25) and optionally cartridge cover 222 presses on spacers 1810a-i (FIG. 18), which places a small amount of pressure on filter cover 226, filter element 228, filter cover 230, and cap 232, thereby holding fluid distributor 224, filter cover 226, filter element 228, filter cover 230, and cap 232 together so water does not exit through the top or bottom of filter element 228.

In an embodiment, each of the steps of method 3000 is a distinct step. In another embodiment, although depicted as distinct steps in FIG. 30, steps 3002-3014 may not be distinct steps. In other embodiments, method 3000 may not have all of the above steps and/or may have other steps in addition to or instead of those listed above. The steps of method 3000 may be performed in another order. Subsets of the steps listed above as part of method 3000 may be used to form their own method.

### Method of Assembly of Filter Head of Filter

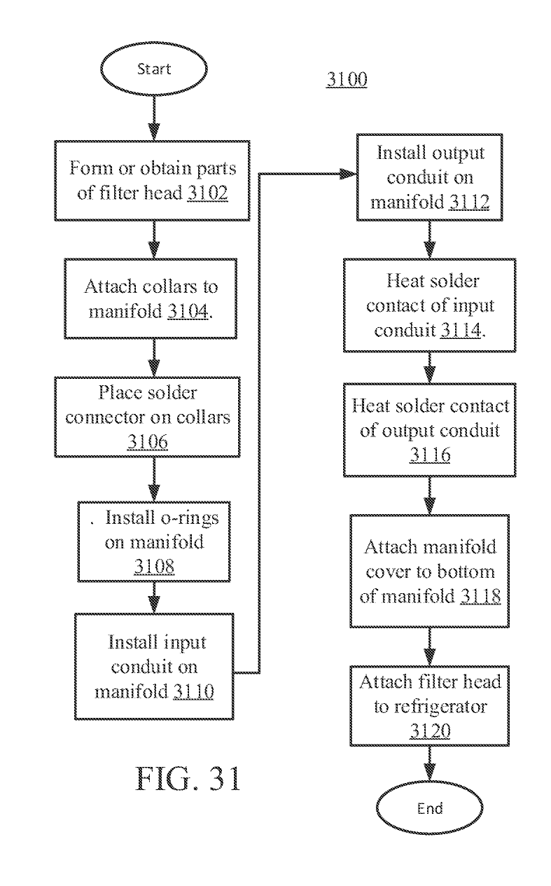

FIG. 31 is a flowchart of an embodiment of a method 3100 of making the fluid filter system.

In step 3102, input conduit 202, output conduit 204, the manifold 206, manifold cover 208, screws 210-218 (FIG. 2), o-ring 804, solder for solder connector 806, collar 808, o-ring 810, and solder for solder connector 812, and collar 816 (FIG. 8) are formed.

In step 3104, collars 808 and 816 are attached to tubular extensions 206a and 206b, respectively. In step 3106, solder connectors 806 and 812 are placed on collars 808 and 816, respectively. In step 3108, o-rings 804 and 810 are placed on tubular extensions 206a and 206b. In step 3110, input conduit 202 is placed on tubular extension 206a. In step 3112, output conduit 204 is placed on tubular extension 206b conduit 202 is connected manifold 206. In step 3114, input conduit 202 is heated near solder ring 808, to attach input conduit to tubular extension 206a. In step 3116, output conduit 204 is heated near solder ring 816, to attach input conduit to tubular extension 206b. In step 3118, manifold cover 208 is attached to manifold 206. Step 3118 may include placing manifold cover 208 on the bottom of manifold 206, with holes 906a-d (FIG. 9) aligned with holes 702a-d (FIG. 7), and then placing screws 210-218 into holes 906a-d and screwed into holes 702a-d. In step 3120, manifold 206 is attached to refrigerator door 2704a (FIG. 27). Step 3120 may include placing slots 504, 506, and/or 508 (FIG. 5) on matching flanges of refrigerator 2702, and screwing manifold 206 to refrigerator 2702, via holes 304 and 314 (FIG. 3).

In an embodiment, each of the steps of method 3100 is a distinct step. In another embodiment, although depicted as distinct steps in FIG. 10, steps 3102-3020 may not be distinct steps. In other embodiments, method 3000 may not have all of the above steps and/or may have other steps in addition to or instead of those listed above. The steps of method 3100 may be performed in another order. Subsets of the steps listed above as part of method 3100 may be used to form their own method.

### Alternatives and Extensions

Although this specification uses a refrigerator as an example of an appliance and water as an example of a fluid, any appliance that requires a filtered fluid may be substituted for the refrigerator and any fluid may be substituted for water.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
at least an outside filter that is for installing outside of an appliance, effective for removing heavy metals from water; and
an inside cartridge for installing on a filter head that is within the appliance;
the inside cartridge, when installed on the filter head, forming a seal that stops water leakage from the filter head.

2. The system of claim 1,
the outside filter being mounted outside of a refrigerator; and
the inside cartridge being installed inside of the refrigerator downstream from the outside filter.

3. The system of claim 1,
the inside cartridge including an inside filter element having a filter material that is not effective in removing heavy metals.

4. The system of claim 1, the inside cartridge further comprising a cartridge cover having a neck, the neck having a channel on a side of the neck for accepting fluids and an opening at the top of the neck for fluids to exit.

5. The system of claim 4, the channel having one or more openings, via which fluids can enter.

6. The system of claim 1 further the inside cartridge comprising a fluid distributor having a neck with an opening for fluids to exit, but no opening for fluids to enter.

7. The system of claim 6, the fluid distributor having one or more spacers on an outer surface maintaining space between the fluid distributor and walls of the cartridge, therein allowing fluid to flow outside of the fluid distributor.

8. The system of claim 7,
the outside filter being mounted outside of a refrigerator;
the inside cartridge being installed inside of the refrigerator downstream from the outside filter;
the inside cartridge including at least
an inside filter element having a filter material that is not effective in removing heavy metals;
a cartridge cover having a neck, the neck having a channel on a side of the neck for accepting fluids and an opening at the top of the neck for fluids to exit;
a canister that attaches to the cartridge cover;
a cap that is located between the filter element and an end of the canister that is opposite an end of the canister where the cartridge cover is attached.

9. The system of claim 8 further comprising:
a first filter cover between the cap and the inside filter element; and
a second filter over between the filter distributor and the inside filter element.

10. The system of claim 1 the inside cartridge having no filter.

11. The system of claim 1 further comprising a filter head configured for installing in the refrigerator, the filter head being configured to mate with the filter cartridge.

12. The system of claim 11, the filter head further comprising:
a manifold having
an input port for connecting to an inlet connection,
an output port for connecting to an outlet connection, and
a cavity;
the input port being a first opening that opens into the cavity; and
the output port being a second opening that opens into the cavity.

13. The system of claim 12, the filter head further comprising
an input conduit that connects to the input port, and
an output conduit that connects to the output port.

14. The system of claim 12, the filter head further comprising
a manifold cover that covers the cavity, the manifold cover having an opening configured for accepting the filter cartridge.

15. The system of claim 12, the cavity having a shape that engages a neck of the filter cartridge, such that the input port aligns with an input channel of the filter cartridge and the output port aligns with an output channel of the filter cartridge.

16. A method comprising:
installing at least an outside filter outside of an appliance, the outside filter being effective for removing heavy metals from water; and
installing an inside cartridge on a filter head that is within the appliance, the filter head within the appliance being downstream from the outside filter that is outside of the appliance, such that fluids entering the appliance is first filtered by the outside filter of the appliance and then passes the inside cartridge installed within the appliance; the inside cartridge forming a seal with the filter head that stops water leakage from the filter head.

17. A system comprising:
at least an outside filter that is for installing outside of an appliance, the outside filter being effective for removing heavy metals from water; and
a bypass plug for installing on a filter head that is within the appliance;
the bypass plug forming a seal with the filter head to stop the water leakage from the filter head.
